(19) United States
(12) Patent Application Publication
(10) Pub. No.: US 2011/0249959 A1
(43) Pub. Date: Oct. 13, 2011

(54) VIDEO STORING METHOD AND DEVICE BASED ON VARIABLE BIT ALLOCATION AND RELATED VIDEO ENCODING AND DECODING APPARATUSES

(75) Inventors: Dong-Sun KIM, Seongnam-si (KR); SeungYerl LEE, Seongnam-si (KR); Tae-Ho HWANG, Seoul (KR); Byung-Ho CHOI, Yongin-si (KR)

(73) Assignee: KOREA ELECTRONICS TECHNOLOGY INSTITUTE, Seongnam-si (KR)

(21) Appl. No.: 13/082,937

(22) Filed: Apr. 8, 2011

Related U.S. Application Data
(60) Provisional application No. 61/322,720, filed on Apr. 9, 2010.

(51) Int. Cl. H04N 5/919

(52) U.S. Cl. 386/328; 386/E05.008

(57) ABSTRACT

Provided are a method and device for storing video on the basis of a variable bit allocation to variably control a buffer size. Also provided are video encoding and decoding apparatuses using the same. The device divides a video image to be stored into a plurality of first basic blocks, checks pixel values of second basic blocks for each of the divided first basic blocks, and allocates bits to each of the first basic blocks according to a difference between maximum and minimum values of the checked pixel values. Also, the device compresses and stores pixel information about the first basic block in the allocated bits, and then de-compresses the compressed pixel information according to the maximum and minimum values for each of the first basic blocks.

### BACKGROUND OF THE INVENTION

1. Field of the Invention

The present invention relates to a method and device for storing video on the basis of a variable bit allocation to variably control a buffer size, and to video encoding and decoding apparatuses using the same.

2. Description of the Related Art

With communication related technologies advanced dramatically nowadays, the use of multimedia contents including video is surprisingly being increased. Moreover, video compression technology is also making a rapid growth in these days.

Scalable video coding (SVC), known as a new version of H.264/AVC video compression standard, is next-generation video compression technology that allows supporting an adaptive scalable function according to devices with different performances and standards (a screen size, etc.) by offering video contents with various resolutions, frame rates and qualities through a single bit stream.

In case of SVC that allows a layer-based encoding for various resolutions, it requires a larger amount of time for encoding than typical coding techniques such as MPEG or H.264, so a great difference in time between an input image and a coded image may be caused. Especially, this time difference may arise much seriously and irregularly in high resolution or high definition (HD) video.

Therefore, the existing video encoding or decoding apparatus has a plenty of buffers enough to store N frames and thereby can operate regardless of a difference between input time of video images and calculation time of encoding/decoding.

However, this conventional structure needs too many memories, so it may disallow SoC or FPGA to fully accommodate such memories. If external memories are used instead, access to external memories may lead to excessive power consumption and lower operating speed in the encoding or decoding apparatus.

As shown in FIG. 1, an SVC-based video encoding apparatus performs motion estimation and compensation on the basis of a reference image through a motion estimation/compensation unit 140 before performing discrete cosine transformation and quantization for an input image through a discrete cosine transform (DCT) unit 110 and a quantization unit 120. Then the encoding apparatus sequentially performs discrete cosine transformation and quantization for a difference between the input image and a predicted image. As shown in FIG. 2, an SVC-based video decoding apparatus performs de-quantization and inverse discrete cosine transformation for an encoded image through a de-quantization unit 210 and an inverse DCT (IDCT) unit 220 and then outputs a decoded image by adding motion compensation values of the reference image through a motion compensation unit 240.

As discussed above, video buffers 130 and 230 for storing the reference image are always needed to perform SVC-based video encoding and decoding.

Therefore, required in the art is a new scheme to minimize the use of memories for storing input video images or reference images so as to improve performance of video encoding and decoding.

### BRIEF SUMMARY OF THE INVENTION

Accordingly, the present invention is to address the above-mentioned problems and/or disadvantages and to offer at least the advantages described below.

An aspect of the present invention is to provide a method and device for storing video on the basis of a variable bit allocation and also to provide video encoding and decoding apparatuses using the same, allowing a video image to be compressed and stored in a buffer and thereby minimizing the use of memory and the degradation of picture quality.

Another aspect of the present invention is to provide a method and device for storing video on the basis of a variable bit allocation and also to provide video encoding and decoding apparatuses using the same, allowing a variable control for the size of a buffer for storing a video image according to the state of the image and thereby minimizing the degradation of picture quality.

According to one aspect of the present invention, provided is a method for storing video on the basis of a variable bit allocation, the method comprising: dividing a video image to be stored into a plurality of first basic blocks; checking pixel values of second basic blocks for each of the first basic blocks and then storing a maximum value and a minimum value selected among the checked pixel values; calculating the number of necessary bits for each of the first basic blocks on the basis of a difference between the stored maximum and minimum values; and allocating the calculated bits to each of the first basic blocks and then compressing and storing pixel information about each of the first basic blocks in the allocated bits.

The method may further comprise: checking the bits allocated to each of the first basic blocks for a video image stored in a video buffer by using the stored maximum and minimum values; and reading the compressed and stored pixel information about each of the first basic blocks from the checked bits and then de-compressing the pixel information for each of the first basic blocks by using both the pixel information and the maximum and minimum values of the corresponding first basic block.

In the method, the first basic block may have a size of 8×8 pixels, and the second basic block may have a size of 4×4 pixels.

In the method, the total number of bits allocated to the first basic block may not exceed 8×8×M (M means the length of bits required for a single pixel).

In the method, the compressing and storing of the pixel information may include storing difference values in the allocated bits, each of the difference values being a value between the pixel value of each of the second basic blocks contained in the first basic block and the maximum or minimum value.

Also, in the method, the number of necessary bits for each of the first basic blocks may be a multiplication of the number of bits required for expressing a difference between the maximum and minimum values and the number of the second basic blocks constituting the first basic block.

According to another aspect of the present invention, provided is a device for storing video on the basis of a variable bit allocation, the device comprising: a max-min calculation module configured to divide a video image to be stored into a plurality of first basic blocks, to check pixel values of second basic blocks for each of the first basic blocks, and then to calculate a maximum value and a minimum value among the checked pixel values; a max-min table configured to store the calculated maximum and minimum values therein; a bit allocation module configured to calculate the number of necessary bits for each of the first basic blocks on the basis of a difference between the stored maximum and minimum values, and to allocate the calculated bits of a video buffer to each of the first basic blocks; and a video compression module configured to compress and store pixel information about each of the first basic blocks in the allocated bits.

The device may further comprise: a bit allocation analysis module configured to check the bits allocated to each of the first basic blocks according to the difference between the maximum and minimum values stored in the max-min table; and a video de-compression module configured to read the compressed and stored pixel information from the bits checked by the bit allocation analysis module, and then to de-compress the pixel information for each of the first basic blocks by using both the pixel information and the maximum and minimum values of the corresponding first basic block. Also, the device may further comprise a video buffer configured to store the pixel information compressed by the video compression module.

According to still another aspect of the present invention, provided is a video encoding apparatus comprising: a motion estimation/compensation unit configured to predict a next image through a motion estimation and compensation for a reference image; a discrete cosine transform (DCT) unit configured to perform a discrete cosine transformation for a difference between an input image and the image predicted by the motion estimation/compensation unit; a quantization unit configured to quantize the image discrete-cosine-transformed by the DCT unit and then to output an encoded image; a de-quantization unit configured to de-quantize the image quantized by the quantization unit in order to store the reference image; an inverse DCT (IDCT) unit configured to perform an inverse discrete cosine transformation for signals outputted from the de-quantization unit and then to restructure as an original image prior to encoding; and a variable bit based video storing unit configured to divide the image restructured by the IDCT unit into a plurality of first basic blocks, to check pixel values of second basic blocks for each of the divided first basic blocks, to allocate bits to each of the first basic blocks according to a difference between maximum and minimum values of the checked pixel values, to compress and store pixel information about the first basic block in the allocated bits, to de-compress the compressed pixel information according to the maximum and minimum values for each of the first basic blocks, and then to offer the reference image.

According to yet another aspect of the present invention, provided is a video decoding apparatus comprising: a de-quantization unit configured to receive an encoded video image and then to de-quantize the received image; an inverse discrete cosine transform (IDCT) unit configured to perform an inverse discrete cosine transformation for the image quantized by the de-quantization unit; a motion compensation unit configured to perform a motion compensation for a reference image and then to output a decoded image by mixing the motion-compensated image with the image transformed by the IDCT unit; and a variable bit based video storing unit configured to divide the decoded image into a plurality of first basic blocks, to check pixel values of second basic blocks for each of the divided first basic blocks, to allocate bits to each of the first basic blocks according to a difference between maximum and minimum values of the checked pixel values, to compress and store pixel information about the first basic block in the allocated bits, to de-compress the compressed pixel information according to the maximum and minimum values for each of the first basic blocks, and then to offer the reference image.

According to aspects of the present invention, by compressing a video image for each first basic block with a specific size while variably allocating the number of bits according to state of the first basic block, it is possible to minimize the degradation of picture quality in compressed images.

Furthermore, this invention may reduce the capacity of a buffer required for video coding and decoding. Therefore, the internal memory only provided in SoC or FPGA may allow video coding and decoding, thus preventing excessive power consumption and lower operating speed due to the use of external memories.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

FIG. 1 is a block diagram illustrating a basic structure of an SVC-based video encoding apparatus.

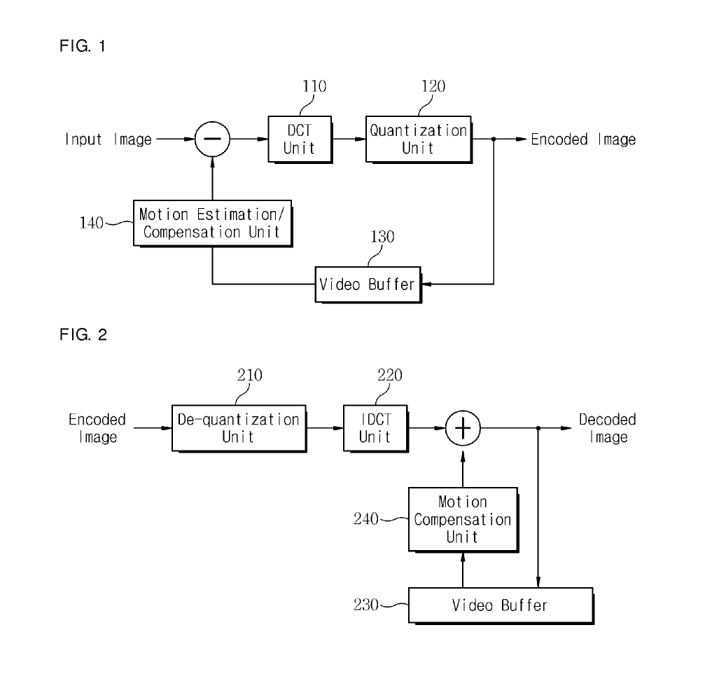

FIG. 2 is a block diagram illustrating a basic structure of an SVC-based video decoding apparatus.

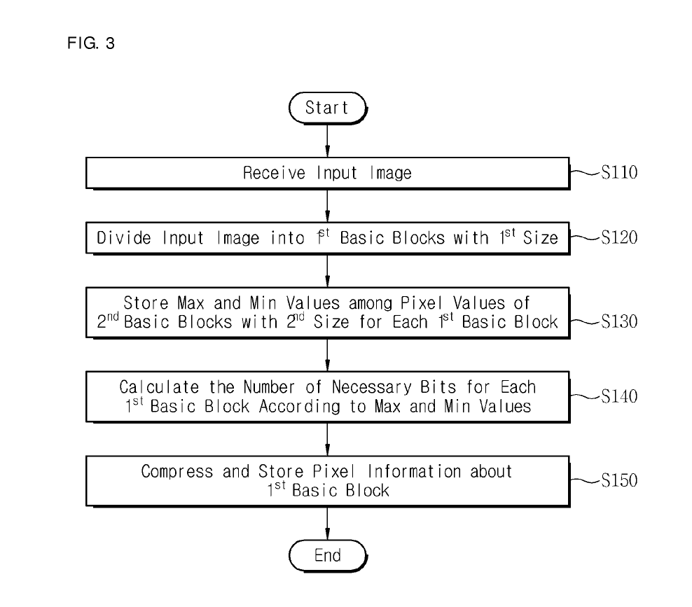

FIGS. 3 and 4 are flow diagrams illustrating a video storing method based on a variable bit allocation in accordance with an exemplary embodiment of the present invention.

FIG. 5 is a block diagram illustrating a video encoding apparatus using a video storing technique based on a variable bit allocation in accordance with an exemplary embodiment of the present invention.

FIG. 6 is a block diagram illustrating a video decoding apparatus using a video storing technique based on a variable bit allocation in accordance with an exemplary embodiment of the present invention.

### DETAILED DESCRIPTION OF THE INVENTION

Exemplary, non-limiting embodiments of the present invention will now be described more fully with reference to the accompanying drawings. This invention may, however, be embodied in many different forms and should not be construed as limited to the exemplary embodiments set forth herein. Rather, the disclosed embodiments are provided so that this disclosure will be thorough and complete, and will fully convey the scope of the invention to those skilled in the art. The principles and features of this invention may be employed in varied and numerous embodiments without departing from the scope of the invention.

Furthermore, well known or widely used techniques, elements, structures, and processes may not be described or illustrated in detail to avoid obscuring the essence of the present invention. Although the drawings represent exemplary embodiments of the invention, the drawings are not necessarily to scale and certain features may be exaggerated or omitted in order to better illustrate and explain the present invention.

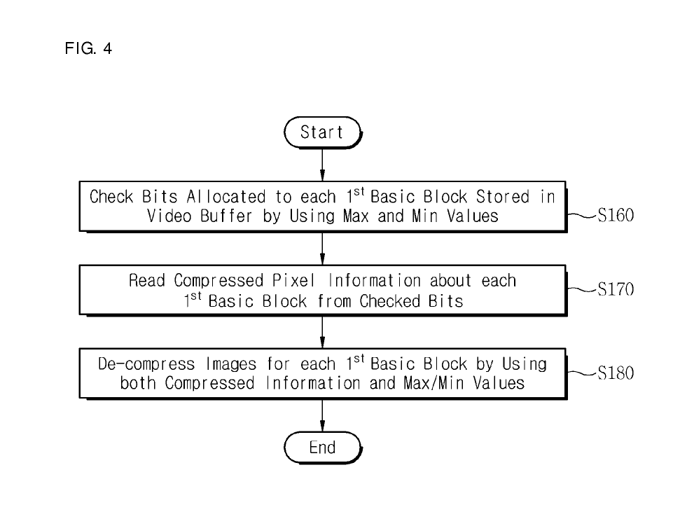

At the outset, a method for storing video on the basis of a variable bit allocation will be described with reference to FIGS. 3 and 4. This method to be discussed hereinafter may be applied to store video images, especially input images or reference images in a video encoding or decoding process.

FIG. 3 is a flow diagram illustrating steps of compressing and storing video images in a video storing method based on a variable bit allocation in accordance with an exemplary embodiment of the present invention, and FIG. 4 is a flow diagram illustrating steps of interpreting the compressed video images.

Referring to FIG. 3, the method of this invention begins with receiving an input video image to be stored (S110). Here, video images are inputted by a frame unit or field unit and their resolution or data format is not much limited. For instance, each pixel of an input image may be expressed in the form of 4:4:4 YUV or 4:2:2 YUV.

The input image is divided into a plurality of the first basic blocks having the first size (S120). This is for processing the image by a block unit. The first size may be set as the size of a macro block that is mainly used for a conventional block-based video compression. For instance, the first basic block may have the size of 8×8.

Next step is to check pixel values of the second basic blocks having the second size with regard to each of the first basic blocks and then to store the maximum value and the minimum value among checked pixel values (S130). In this step, the maximum value and the minimum value for each of the first basic blocks are stored in a max-min table. For instance, the respective first basic blocks may be sequentially checked from left to right in the input image, and then the maximum and minimum values of each first basic block may be sequentially stored in the max-min table.

Additionally, the second size is smaller than the first size. For instance, the second size may be 4×4. Namely, pixel values of the first basic block with 8×8 size are checked for the second basic blocks with 4×4 size. Then the maximum and minimum values are selected among pixel values of a plurality of the second basic blocks contained in the single first basic block. Meanwhile, the pixel value of the second basic block may be an average value of 4×4 pixels contained in the second basic block.

Next step is to calculate the number of necessary bits on the basis of the stored maximum and minimum values with regard to each of the first basic blocks (step S140). Specifically, the number of necessary bits may be calculated on the basis of a difference between the maximum and minimum values. In this disclosure, the number of necessary bits means the total number of bits required for expressing the pixel value of each of the second basic blocks contained in the first basic block as a difference from the maximum value (or the minimum value). Therefore, the number of necessary bits for each of the first basic blocks may be expressed as a multiplication of the number of bits required for expressing a difference between the maximum and minimum values and the number of the second basic blocks constituting the first basic block.

Next step is to allocate the calculated number of bits to a video buffer and then to compress and store pixel information about the first basic block (S150). Specifically, difference values between pixel values of the respective second basic blocks in the first basic block and the stored maximum value (or minimum value) are stored in bits of the calculated number. In this invention, the type or capacity of the video buffer for storing compressed video is not limited, only the total number of bits allocated to the first basic block should not exceed 8×8×M. Here, M means the length of bits required for a single pixel.

Therefore, different bits in number may be allocated to each of the first basic blocks, depending on the state of the first basic block, when input video images are compressed and stored, and it is possible to effectively store pixel information about each first basic block through the allocation of bits. For instance, the first basic block with a relatively smaller difference between the maximum and minimum values may allow pixel information to be compressed through relatively smaller bits in number in comparison with the first basic block with a relatively greater difference.

Meanwhile, in order to retrieve the compressed video images from the video buffer, it is required to de-compress the video images for each of the first basic blocks by using both the compressed pixel information and the stored maximum and minimum values. This may be performed as shown in FIG. 4.

Referring to FIG. 4, when there is a request for the compressed video images, performed is to check bits allocated to each of the first basic blocks stored in the video buffer by using the maximum and minimum values stored in the step S130 (S160). Namely, by similarly applying the principle of calculating the number of necessary bits through the maximum and minimum values in the step S140, bits allocated to video images to be displayed are checked for each first basic block through the stored maximum and minimum values.

Next steps are to read the compressed and stored pixel information about each first basic block from the video buffer by using the checked bits (S170), and then to de-compress the video images for each of the first basic blocks by using both the compressed pixel information and the stored maximum and minimum values of each first basic block (S180). For instance, the original pixel value of each second basic block is calculated by combining a difference value recorded in the compressed pixel information with the corresponding maximum and minimum values. By repeatedly performing this process for all of the first basic blocks, the entire video images are de-compressed.

Through the above-discussed processes in FIGS. 3 and 4, it may be allowed to compress and store video images with minimizing degradation of picture quality and thereby to reduce the use of the video buffer.

The above-described method according to the present invention can be implemented in hardware or as software or computer code that can be stored in a recording medium including magnetic media such as a hard disk, a floppy disk and a magnetic tape, optical media such as a CD ROM (Compact Disk Read Only Memory) and a DVD (Digital Video Disk), or magneto-optical media such as a floptical disk, so that the method described herein can be rendered in such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

Particularly, the above-discussed method of this invention may be applied to store input video images and/or reference video images in a video encoding apparatus and a video decoding apparatus.

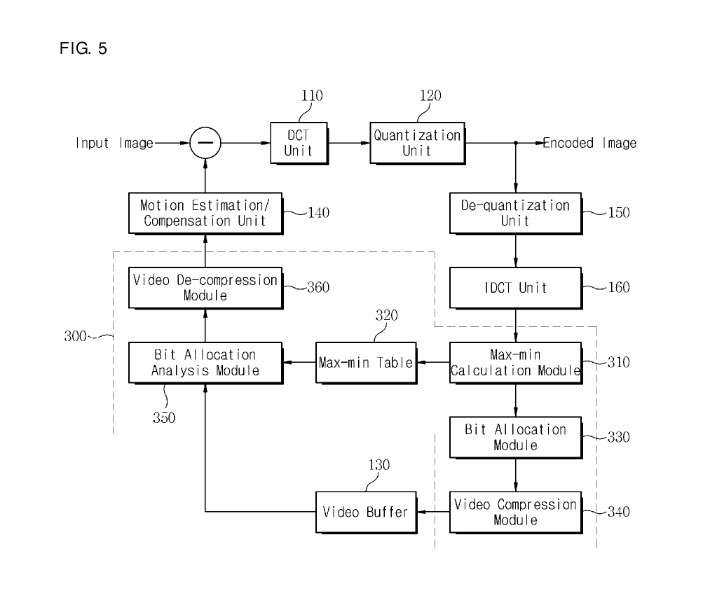

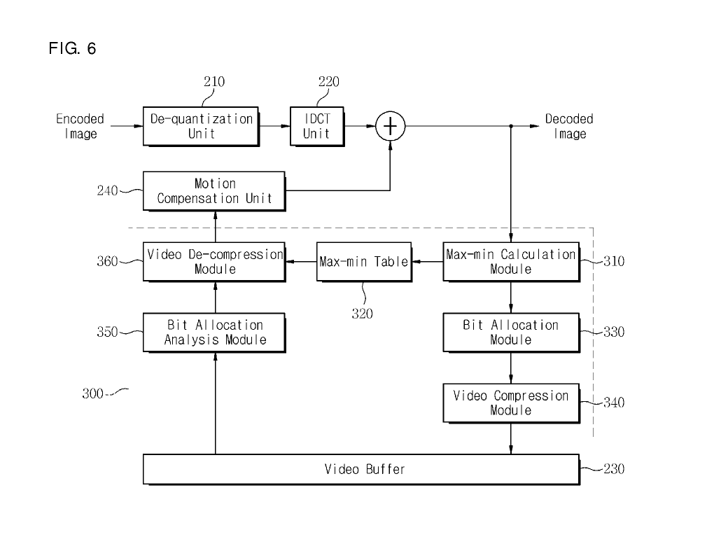

FIG. 5 is a block diagram illustrating a video encoding apparatus using a video storing technique based on a variable bit allocation in accordance with an exemplary embodiment of the present invention, and FIG. 6 is a block diagram illustrating a video decoding apparatus using a video storing technique based on a variable bit allocation in accordance with an exemplary embodiment of the present invention.

On the one hand, referring to FIG. 5, the video encoding apparatus may include a discrete cosine transform (DCT) unit 110, a quantization unit 120, a video buffer 130, a motion estimation/compensation unit 140, a de-quantization unit 150, an inverse DCT (IDCT) unit 160, and a variable bit based video storing unit 300.

Additionally, the variable bit based video storing unit 300 may include a max-min calculation module 310, a max-min table 320, a bit allocation module 330, a video compression module 340, a bit allocation analysis module 350, and a video de-compression module 360.

This video encoding apparatus performs a video coding according to a predefined coding procedure. Specifically, the DCT unit 110 performs a discrete cosine transformation for a difference between an image predicted by the motion estimation/compensation unit 140 and an input image. Also, the quantization unit 120 performs a quantization for a discrete-cosine-transformed image and then outputs an encoded image.

Additionally, the image encoded by the quantization unit 120 is stored as a reference image for the next input image in the video buffer 130. When the next image is inputted, the motion estimation/compensation unit 140 executes a next image prediction through ME/MC technique for the reference image stored in the video buffer 130.

The variable bit based video storing unit 300 compresses each block of an image to be stored in the video buffer 130, de-compresses the compressed image, and offers it to the motion estimation/compensation unit 140.

Specifically, since a target to be stored in the video buffer 130 is an encoded image, the variable bit based video storing unit 300 should restructure the encoded image to an original image prior to encoding before performing a variable bit based video storing process.

For the above, the de-quantization unit 150 performs a de-quantization for the encoded image, and the IDCT unit 160 performs an inverse discrete cosine transformation for the de-quantized image and then offers it to the variable bit based video storing unit 300.

When an image stored as a reference image is inputted, the variable bit based video storing unit 300 allocates variable bits to each of the first basic blocks and then compresses the inputted image as discussed above.

Specifically, the max-min calculation module 310 divides an image to be stored into a plurality of the first basic blocks having the first size, checks pixel values of the second basic blocks having the second size with regard to each of the divided first basic blocks, and then calculates the maximum value and the minimum value for each first basic block.

The maximum and minimum values calculated by the max-min calculation module 310 for each of the first basic blocks are stored in the max-min table 320.

Next, the bit allocation module 330 calculates and allocates the number of bits required for each first basic block, depending on a difference between the stored maximum and minimum values. Since different bits in number are allocated depending on the state (i.e., a difference between the maximum and minimum values) of the first basic block, a variable bit allocation is realized.

After a bit allocation, the video compression module 340 compresses and stores pixel information about the first basic block in specific bits allocated by the bit allocation module 330. Here, the pixel information compressed and stored may be a difference value from the maximum value (or minimum value).

The bit allocation analysis module 350 calculates bits allocated to each of the first basic blocks, depending on a difference between the maximum and minimum values for each first basic block stored in the max-min table 320. A bit calculation in the bit allocation analysis module 350 may be similar to that in the bit allocation module 330.

The video de-compression module 360 reads the pixel information compressed and stored for each first basic block from the video buffer 130, using information about a bit allocation checked by the bit allocation analysis module 350. Also, the video de-compression module 360 calculates original pixel values for each first basic block from the pixel information read for each first basic block and from the maximum and minimum values of each first basic block stored in the max-min table 320. Then the video de-compression module 360 de-compresses and outputs the compressed reference image.

Since performed being based on the variable bit based video storing method earlier described in FIGS. 3 and 4, the above-discussed operation of the variable bit based video storing unit 300 may be much easily understood from the above-discussed method.

On the other hand, referring to FIG. 6, the video decoding apparatus may include a de-quantization unit 210, an IDCT unit 220, a video buffer 230, a motion compensation unit 240, and a variable bit based video storing unit 300. Here, the variable bit based video storing unit 300 is the same element as discussed in FIG. 5.

In the video decoding apparatus, when an encoded video image (i.e., a bit stream) is inputted, the de-quantization unit 210 de-quantizes the input image and then the IDCT unit 220 performs an inverse discrete cosine transformation for the de-quantized image. Also, the motion compensation unit 240 performs a motion compensation for a reference image stored in the video buffer 230 and then outputs a decoded video image by mixing the motion-compensated image with the output image from the IDCT unit 220.

The decoded image outputted from the video decoding apparatus is stored as a reference image for decoding of the next input image in the video buffer 230. When storing the reference image, the variable bit based video storing unit 300 divides the decoded image into a plurality of the first basic blocks, checks pixel values of the second basic blocks for each of the divided first basic blocks, allocates bits to each first basic block according to a difference between the maximum and minimum values of the checked pixel values, compresses and stores pixel information about the first basic block in the allocated bits, de-compresses the compressed image according to the maximum and minimum values for each first basic block, and then offers the reference image to the motion compensation unit 240.

In the variable bit based video storing unit 300, the max-min calculation module 310, the max-min table 320, the bit allocation module 330, the video compression module 340, the bit allocation analysis module 350, and the video de-compression module 360 perform the same operation as in the above-discussed video encoding apparatus.

The variable bit based video storing unit 300 applied to both the video encoding apparatus and the video decoding apparatus is a means for realizing the variable bit based video storing method of this invention and may be formed as an independent device by selectively including the video buffer 130 or 230.

Table 1 shows a comparison in performance between the method of this invention and conventional methods. A reference image compression method suggested in H.264 and a reference image compression method using a fixed length bit allocation are used as conventional methods.

As shown in Table 1, the method according to this invention achieves improvements in BD-PSNR by 0.04 dB on average and in BD bit rate by 1.7% on average. Furthermore, the amount of consuming memories is reduced by about 37.5% in comparison with conventional methods.

Meanwhile, on the whole, the degradation of picture quality is less caused in larger screens rather than smaller screens. This is because the probability of a flat region in a larger screen is greater than in a smaller screen.

TABLE 1

| | | h.264 | | fixed min-max | | average | | proposed | | average | |
|---|---|---|---|---|---|---|---|---|---|---|---|
| | | bit | | bit | | BD | BD bit | bit | | BD | BD bit |
| | QP | rate | PSNR | rate | PSNR | PSNR | rate | rate | PSNR | PSNR | rate |
| foreman.cif | 22 | 1181.8 | 40.5 | 1262 | 40 | −0.47 | 12.782 | 1237.8 | 40.2 | −0.35 | 9.1927 |
| | 27 | 505.35 | 37 | 535.6 | 36.7 | | | 528.93 | 36.8 | | |
| | 32 | 210.3 | 33.7 | 220 | 33.4 | | | 218.01 | 33.5 | | |
| | 37 | 103.24 | 30.8 | 106.2 | 30.6 | | | 105.74 | 30.6 | | |
| silent.cif | 22 | 550 | 40.3 | 578 | 40 | −0.25 | 5.8737 | 571.62 | 40 | −0.19 | 2.49 |
| | 27 | 267.46 | 36.6 | 274.9 | 36.4 | | | 272.86 | 36.5 | | |
| | 32 | 127.91 | 33.3 | 130.3 | 33.2 | | | 129.41 | 33.2 | | |
| | 37 | 61.14 | 31.5 | 64.14 | 31.5 | | | 64.32 | 30.5 | | |
| suzie.cif | 22 | 774.04 | 41.7 | 789.3 | 42.5 | −0.12 | 3.4814 | 784.3 | 42.6 | −0.09 | 12.04 |
| | 27 | 314.4 | 34.8 | 361.6 | 39.4 | | | 359.56 | 39.4 | | |
| | 32 | 144.14 | 36.4 | 144.1 | 36.4 | | | 144.55 | 26.4 | | |
| | 37 | 63.14 | 33.9 | 64.34 | 33.8 | | | 63.91 | 33.8 | | |
| mobile.cif | 22 | 3670.1 | 39.1 | 3859 | 37.7 | −0.76 | 15.96 | 3823.2 | 38 | −0.63 | 2.71 |
| | 27 | 1940.1 | 34.9 | 2047 | 34.2 | | | 2027.7 | 34.3 | | |
| | 32 | 540.1 | 30.5 | 885.8 | 30.1 | | | 879.69 | 30.2 | | |
| | 37 | 315.44 | 26.5 | 342.9 | 26.3 | | | 340.27 | 26.3 | | |

This invention may be applied to fields of storing video images in video coding or decoding apparatuses. By compressing a video image for each first basic block with a specific size while variably allocating the number of bits according to state of the first basic block, this invention may minimize the degradation of picture quality in compressed images.

Furthermore, this invention may reduce the capacity of a buffer required for video coding and decoding. Therefore, the internal memory only provided in SoC or FPGA may allow video coding and decoding, thus preventing excessive power consumption and lower operating speed due to the use of external memories.

While this invention has been particularly shown and described with reference to an exemplary embodiment thereof, it will be understood by those skilled in the art that various changes in form and details may be made therein without departing from the spirit and scope of the invention as defined by the appended claims.

What is claimed is:

1. A method for storing video on the basis of a variable bit allocation, the method comprising:
dividing a video image to be stored into a plurality of first basic blocks;
checking pixel values of second basic blocks for each of the first basic blocks and then storing a maximum value and a minimum value selected among the checked pixel values;
calculating the number of necessary bits for each of the first basic blocks on the basis of a difference between the stored maximum and minimum values; and
allocating the calculated bits to each of the first basic blocks and then compressing and storing pixel information about each of the first basic blocks in the allocated bits.

2. The method of claim 1, further comprising:
checking the bits allocated to each of the first basic blocks for a video image stored in a video buffer by using the stored maximum and minimum values; and
reading the compressed and stored pixel information about each of the first basic blocks from the checked bits and then de-compressing the pixel information for each of the first basic blocks by using both the pixel information and the maximum and minimum values of the corresponding first basic block.

3. The method of claim 1, wherein the first basic block has a size of 8×8 pixels.

4. The method of claim 3, wherein the second basic block has a size of 4×4 pixels.

5. The method of claim 3, wherein the total number of bits allocated to the first basic block does not exceed 8×8×M (M means the length of bits required for a single pixel).

6. The method of claim 1, wherein the compressing and storing of the pixel information includes storing difference values in the allocated bits, each of the difference values being a value between the pixel value of each of the second basic blocks contained in the first basic block and the maximum or minimum value.

7. The method of claim 1, wherein the number of necessary bits for each of the first basic blocks is a multiplication of the number of bits required for expressing a difference between the maximum and minimum values and the number of the second basic blocks constituting the first basic block.

8. A device for storing video on the basis of a variable bit allocation, the device comprising:
a max-min calculation module configured to divide a video image to be stored into a plurality of first basic blocks, to check pixel values of second basic blocks for each of the first basic blocks, and then to calculate a maximum value and a minimum value among the checked pixel values;
a max-min table configured to store the calculated maximum and minimum values therein;
a bit allocation module configured to calculate the number of necessary bits for each of the first basic blocks on the basis of a difference between the stored maximum and minimum values, and to allocate the calculated bits of a video buffer to each of the first basic blocks; and
a video compression module configured to compress and store pixel information about each of the first basic blocks in the allocated bits.

9. The device of claim 8, further comprising:
a bit allocation analysis module configured to check the bits allocated to each of the first basic blocks according to the difference between the maximum and minimum values stored in the max-min table; and
a video de-compression module configured to read the compressed and stored pixel information from the bits checked by the bit allocation analysis module, and then to de-compress the pixel information for each of the first basic blocks by using both the pixel information and the maximum and minimum values of the corresponding first basic block.

10. The device of claim 8, further comprising:
a video buffer configured to store the pixel information compressed by the video compression module.

11. A video encoding apparatus comprising:
a motion estimation/compensation unit configured to predict a next image through a motion estimation and compensation for a reference image;
a discrete cosine transform (DCT) unit configured to perform a discrete cosine transformation for a difference between an input image and the image predicted by the motion estimation/compensation unit;
a quantization unit configured to quantize the image discrete-cosine-transformed by the DCT unit and then to output an encoded image;
a de-quantization unit configured to de-quantize the image quantized by the quantization unit in order to store the reference image;
an inverse DCT (IDCT) unit configured to perform an inverse discrete cosine transformation for signals outputted from the de-quantization unit and then to restructure as an original image prior to encoding; and
a variable bit based video storing unit configured to divide the image restructured by the IDCT unit into a plurality of first basic blocks, to check pixel values of second basic blocks for each of the divided first basic blocks, to allocate bits to each of the first basic blocks according to a difference between maximum and minimum values of the checked pixel values, to compress and store pixel information about the first basic block in the allocated bits, to de-compress the compressed pixel information according to the maximum and minimum values for each of the first basic blocks, and then to offer the reference image.

12. The apparatus of claim 11, wherein the variable bit based video storing unit includes:
a max-min calculation module configured to divide a video image to be stored into the first basic blocks, to check the pixel values of the second basic blocks for each of the first basic blocks, and then to calculate the maximum value and the minimum value among the checked pixel values;
a max-min table configured to store the maximum and minimum values calculated by the max-min calculation module;
a bit allocation module configured to allocate the bits to each of the first basic blocks according to the difference between the maximum and minimum values;
a video compression module configured to compress and store the pixel information about each of the first basic blocks in the bits allocated by the bit allocation module;
a video buffer configured to store the pixel information compressed by the video compression module;
a bit allocation analysis module configured to check the bits allocated to each of the first basic blocks according to the difference between the maximum and minimum values stored in the max-min table; and
a video de-compression module configured to read and de-compress the compressed and stored pixel information from the video buffer according to check results by the bit allocation analysis module, and then to offer the reference image.

13. A video decoding apparatus comprising:
a de-quantization unit configured to receive an encoded video image and then to de-quantize the received image;
an inverse discrete cosine transform (IDCT) unit configured to perform an inverse discrete cosine transformation for the image quantized by the de-quantization unit;
a motion compensation unit configured to perform a motion compensation for a reference image and then to output a decoded image by mixing the motion-compensated image with the image transformed by the IDCT unit; and
a variable bit based video storing unit configured to divide the decoded image into a plurality of first basic blocks, to check pixel values of second basic blocks for each of the divided first basic blocks, to allocate bits to each of the first basic blocks according to a difference between maximum and minimum values of the checked pixel values, to compress and store pixel information about the first basic block in the allocated bits, to de-compress the compressed pixel information according to the maximum and minimum values for each of the first basic blocks, and then to offer the reference image.

14. The apparatus of claim 13, wherein the variable bit based video storing unit includes:
a max-min calculation module configured to divide a video image to be stored into the first basic blocks, to check the pixel values of the second basic blocks for each of the first basic blocks, and then to calculate the maximum value and the minimum value among the checked pixel values;
a max-min table configured to store the maximum and minimum values calculated by the max-min calculation module;
a bit allocation module configured to allocate the bits to each of the first basic blocks according to the difference between the maximum and minimum values;
a video compression module configured to compress and store the pixel information about each of the first basic blocks in the bits allocated by the bit allocation module;
a video buffer configured to store the pixel information compressed by the video compression module;
a bit allocation analysis module configured to check the bits allocated to each of the first basic blocks according to the difference between the maximum and minimum values stored in the max-min table; and
a video de-compression module configured to read and de-compress the compressed and stored pixel information from the video buffer according to check results by the bit allocation analysis module, and then to offer the reference image.
